(19) United States
(12) Patent Application Publication
(10) Pub. No.: US 2024/0313240 A1
(43) Pub. Date: Sep. 19, 2024

(54) ALKALINE FUEL CELL STACK WITH RECIRCULATING ELECTROLYTE SYSTEM

(71) Applicant: AFC ENERGY PLC, Cranleigh, Surrey (GB)

(72) Inventors: Richard John CARTWRIGHT, Cranleigh, Surrey (GB); Christopher Thomas REYNOLDS, Cranleigh, Surrey (GB); Neill Devereux MAYNARD, Cranleigh, Surrey (GB); Richard Michael TRACY, Cranleigh, Surrey (GB)

(21) Appl. No.: 18/261,639

(22) PCT Filed: Jan. 14, 2022
(86) PCT No.: PCT/GB2022/050082

§ 371 Date: Jul. 14, 2023

(30) Foreign Application Priority Data
Jan. 15, 2021 (GB) 2100553.3

(51) Int. Cl. H01M 8/04276; B60L 53/54; B60L 53/67; H01M 8/083; H01M 8/2465

(52) U.S. Cl. CPC H01M 8/04276; B60L 53/54; B60L 53/67; H01M 8/083; H01M 8/2465

(57) ABSTRACT

An electrolyte chamber assembly (10) for an electrochemical cell 3, the assembly (10) comprising a forward electrolyte flow plate (8) and a rearward electrolyte flow plate 6 that are abutted with each other to form the assembly (10). The inward facing side of each flow plate (6, 8) is provided with an electrolyte inflow channel (15), an electrolyte outflow collector (34) and an electrolyte chamber aperture (14) that are mirror images of the electrolyte inflow channel (15), the electrolyte outflow collector (34) and the electrolyte chamber aperture (14) on the other flow plate (6, 8). The two electrolyte inflow channels (15) create together an electrolyte inflow pipe (16), the two electrolyte outflow collectors (34) create together an electrolyte outflow pipe 32 and the two electrolyte chamber apertures (14) create together an electrolyte chamber (19).

The present invention relates to an alkaline fuel cell stack with a system for recirculating an electrolyte, for example potassium hydroxide (KOH), through the electrolyte chambers of the electrochemical cells within the stack, as well as to a power supply system comprising the alkaline fuel cell stack, such as for charging electric vehicles or powering an electrical device.

The electrolyte flows through all of the electrochemical cells and their electrolyte chambers in parallel. On the inflow side of each electrochemical cell there is an electrolyte inflow tube, through which electrolyte can flow into the electrolyte chamber, and on the outflow side there is an electrolyte outflow tube, through which the electrolyte passes as it leaves the electrochemical cell. This flow arrangement allows the electrolyte to circulate through the electrochemical cells in the stack, however, it also allows an ionic current leakage to pass between those cells, via the electrolyte inflow and outflow tubes and this results in a reduction in the power output of the stack. It is clearly important to minimise this lost power and this must be done by reducing the size of the ionic current leakage.

It is known that increasing the ionic resistance of the inflow and outflow tubes will result in a reduction in the ionic current leakage and it is known that the ionic resistance of such inflow and outflow tubes can be increased by increasing their length and reducing their area. However, it is not possible to implement both an electrolyte inflow tube and an electrolyte outflow tube that each have a very long length and a very small cross-sectional area, so that they each have a very high ionic resistance. If such an arrangement is utilised for the outlet tube, then it would not be possible to obtain the desired pressure of electrolyte within the electrolyte chamber. The electrolyte chamber would operate at higher pressure than required.

If the length of the electrolyte outflow tube is too great and its cross-sectional area is too small, then the flow rate of electrolyte out of the electrolyte chamber would be too restricted. It is essential to avoid over-pressurisation of the electrolyte chamber for a number of reasons. The electrolyte chamber is bounded on two opposed sides by electrodes and if the pressure within the electrolyte chamber is high enough then electrolyte will be forced into the electrodes. This would upset the pressure balance between the liquid and gas phases which may cause problems, for example flooding of the electrodes. This would result in a reduction in the area of the interface available for reaction. Forcing electrolyte into the electrodes may also result in them suffering permanent damage.

A high resistance to electrolyte flow on the outflow from the electrochemical cell may also result in a low flow of electrolyte which can be problematic if that flow is insufficient to remove the desired amount of heat from the fuel cell stack.

Consequently, it can be seen that there are a number of challenges to be met by the design of an electrolyte flow system for a fuel cell stack. The present invention seeks to address those challenges.

According to the present invention there is provided an electrolyte chamber assembly for an electrochemical cell, the assembly comprising a forward electrolyte flow plate and a rearward electrolyte flow plate, each having an inward facing side and an outward facing side, wherein each inward facing side is provided on its surface with an electrolyte inflow channel and an electrolyte outflow collector and an electrolyte chamber aperture that passes between the surface of the inward facing side and the surface of the outward facing side of each of the forward electrolyte flow plate and the rearward electrolyte flow plate, wherein the electrolyte inflow channel, the electrolyte outflow collector and the electrolyte chamber aperture on the inward facing side of one of the electrolyte flow plates are mirror images of the electrolyte inflow channel, the electrolyte outflow collector and the electrolyte chamber aperture on the inward facing side of the other of the forward and rearward electrolyte flow plates, wherein the forward and rearward electrolyte flow plates are held against each other in the electrolyte chamber assembly and the inward facing side of the forward electrolyte flow plate and the inward facing side of the rearward electrolyte flow plate are held in abutment with each other, whereby the two electrolyte inflow channels create together an electrolyte inflow pipe, the two electrolyte outflow collectors create together an electrolyte outflow pipe and the two electrolyte chamber apertures create together an electrolyte chamber, and wherein the electrolyte inflow pipe has an inlet end for receiving electrolyte into the electrolyte chamber assembly and an outlet end fluidly connected to the electrolyte chamber and the electrolyte outflow pipe has an inlet end connected to the electrolyte chamber and an outlet end for exhausting electrolyte from the electrolyte chamber assembly, the electrolyte inflow pipe having a higher ionic resistance than the electrolyte outflow pipe. The creation of pipes by abutting two flow plates with each other enables the thickness of the flow plates to be reduced. This reduces the thickness of the flow plates and thus the overall length of the fuel cell stack.

Preferably, the electrolyte outflow collectors each comprise a tapering recess and an electrolyte outflow channel, the tapering recess tapers from a mouth to a throat, the mouth is fluidly connected to the electrolyte chamber aperture and the throat is fluidly connected to the electrolyte outflow channel, wherein, when the forward and rearward electrolyte flow plates are abutted with each other, the tapering recesses create together an electrolyte outflow funnel and the electrolyte outflow channels of the forward and rearward electrolyte flow plate create together an electrolyte outflow duct, which are each part of the electrolyte outflow pipe. The electrolyte outflow funnel assists with the creation of an even flow of electrolyte across the width of the electrolyte chamber, from the electrolyte inflow plenum to the electrolyte outflow plenum, by avoiding favouring the flow of electrolyte through the central section of the electrolyte chamber. The electrolyte outflow funnel also assists with the extraction of gas bubbles out of the electrochemical cell.

Preferably, each electrolyte outflow channel is straight-sided and the electrolyte outflow duct is a straight-sided duct.

Preferably, each forward and rearward electrolyte flow plate is provided on the surface of its inward facing side with an electrolyte inflow distribution recess which together create an electrolyte inflow plenum and the downstream end of the electrolyte inflow pipe is connected to the electrolyte inflow plenum substantially at the centre point of the transverse width of the electrolyte inflow plenum. Connection of the electrolyte inflow pipe to the centre point of the electrolyte inflow plenum helps to assist with an even distribution of electrolyte across the electrolyte chamber.

Preferably, each of the forward and rearward electrolyte flow plates is provided on the surface of its inward facing side with an electrolyte outflow collection recess and the electrolyte outflow collection recesses together create an electrolyte outflow plenum, wherein the inlet end of the electrolyte outflow pipe is fluidly connected to the electrolyte outflow plenum.

Preferably, the depth of the electrolyte outflow plenum is greater than the depth of the electrolyte outflow funnel, when the depths are measured in a direction perpendicular to the surfaces of the forward and rearward electrolyte flow plates. This arrangement assists with balancing the flow of electrolyte into the electrolyte outflow funnel.

Preferably, the electrolyte inflow pipe is elongate and is tortuous. This is advantageous because it results in the electrolyte inflow pipe having a high ionic resistance and thus contributes to a reduction in the ionic current leakage from the electrochemical cell.

Advantageously, the length of the electrolyte outflow duct is less than the length of the electrolyte inflow pipe. This facilitates a high ionic resistance of the electrolyte inflow pipe, without resulting in an over-pressurisation of the electrolyte chamber.

Preferably, each of the forward and rearward electrolyte flow plates further comprises an electrolyte supply aperture and an electrolyte exhaust aperture which each pass through the forward and rearward electrolyte flow between the surface of their inward facing sides and the surface of their outward facing sides and wherein the electrolyte inflow channel is connected at its inlet to the electrolyte supply aperture and the electrolyte outflow channel is connected at its outlet end to the electrolyte exhaust aperture.

Preferably, the electrolyte exhaust aperture has an electrolyte flow region and a gas flow region and wherein the interface between the electrolyte outflow pipe and the electrolyte exhaust aperture is located within the gas flow region. This arrangement is advantageous because if electrolyte flows into the gas flow region and then drops down into the electrolyte flow region there is an additional means for ionic decoupling of the electrolyte exhaust aperture from the electrolyte cell. This also increases the level of certainty and control over the electrolyte pressure within the cell. As gas is present within the electrolyte chamber at start-up, the arrangement allows any gas to be readily disengaged.

Preferably, each electrolyte chamber aperture is provided with an electrode shelf recess that is located around the perimeter of the electrolyte chamber aperture and that is formed by an inward facing electrode retaining shelf that extends into the surface of the inward facing side of each of the forward and rearward electrolyte flow plates.

Preferably the electrolyte chamber assembly further comprises an electrode support located within the electrolyte chamber, wherein the electrode support is provided with a plurality of support bosses spaced apart by flow paths and an inflow side and an outflow side, wherein each of the inflow side and the outflow side are provided with a plurality of flow apertures that are fluidly connected to the flow paths.

Preferably, the flow apertures are arranged into groups that are aligned with the flow paths and the flow apertures on the inflow side are not evenly spaced within their groups and the flow apertures on the outflow side are evenly spaced within their groups. This arrangement is advantageous because it facilitates an even flow of electrolyte across the electrolyte chamber.

Preferably, the electrode support has an external frame, a plurality of internal bars located inside the frame, attached to the frame and spaced apart from each other to create the flow paths, the internal bars each comprising a spine, on the forward and rearward sides of which spine are provided a plurality of the support bosses, the spaces between the support bosses creating cross-flow channels between adjacent flow paths. The flow paths assist flow of the electrolyte across the electrolyte chamber from the inflow side to the outflow side and the size and spacing of the support bosses minimises any restriction in the flow of the electrolyte. The support bosses obstruct a minimum proportion of the reactive area of the electrodes, whilst providing adequate structural support for the electrodes.

Preferably, the inflow side of the electrode support is provided with a deflector at its centre point and the electrode support is located within the electrolyte chamber so that the deflector is positioned adjacent to the outlet end of the electrolyte inflow pipe, the deflector having deflection surfaces which, in use, deflect electrolyte leaving the electrolyte inflow pipe to either side of the centre point on the electrode support. Deflection of the electrolyte to either side of the centre assists with an even flow of electrolyte across the electrolyte chamber.

In one embodiment of the present invention, the electrolyte inflow pipe has a higher ionic resistance than the electrolyte outflow pipe.

According to a second aspect of the present invention there is provided an electrolyte supply system for a fuel cell stack with a plurality of electrochemical cells, each of the electrochemical cells having an electrolyte chamber connected to an electrolyte inflow pipe and an electrolyte outflow pipe, the electrolyte supply system comprising a common electrolyte supply conduit, through which, in use, electrolyte is supplied to each of the electrochemical cells via the electrolyte inflow pipe, and a common electrolyte exhaust conduit, through which, in use, electrolyte leaves each of the electrochemical cells via the electrolyte outflow pipe, wherein the common electrolyte exhaust conduit has an electrolyte flow region located beneath a gas flow region and the interface between the electrolyte outflow pipe and the common electrolyte exhaust conduit is located in the gas flow region. It will be understood that each of the electrochemical cells may comprise an electrolyte chamber assembly according to the previous aspect.

Preferably, the electrolyte supply system further comprises an electrolyte reservoir located at a height greater than the height of the fuel cell stack, or an equivalent inlet pressure, an electrolyte supply line located between the reservoir and the common electrolyte supply conduit and an electrolyte return line located between the common electrolyte exhaust conduit and the reservoir, so that electrolyte can flow into the electrochemical cells under the force of gravity, an electrolyte pump in the electrolyte return line and an electrolyte inflow control valve in the electrolyte supply line.

In one embodiment of the present invention, the ionic resistance of the inflow pipe is greater than the ionic resistance of the outflow pipe.

According to a third aspect of the present invention there is provided a fuel cell stack comprising a plurality of electrochemical cells, each electrochemical cell having an electrolyte chamber assembly.

According to a fourth aspect of the present invention there is provided a power supply system for charging or powering an electrical device, comprising a fuel cell stack according to the third aspect of the present invention, and a power supply control system electrically connected to the fuel cell stack, and having a connector mechanism, operable to electrically connect the power supply control system to an electrical device. For example, the power supply system may be configured for charging the battery of an electric vehicle (EV), or for providing an uninterrupted power supply (UPS), operable to power an electrical apparatus, or for generating power for a cellular telecommunications transmitter, or for some other stationary power system.

In some example arrangements, the power supply system of the fourth aspect of the present invention may comprise an ammonia cracker system, for processing ammonia to produce hydrogen gas, and a fuel conveyor channel connecting the ammonia cracker system to the fuel cell stack, operable to convey the hydrogen gas from the ammonia cracker system to the fuel cell stack. The fuel gas may consist predominantly of hydrogen, where 99.999% is hydrogen. Alternatively, the percentage of hydrogen might be 99.95%, or 99%. It is also envisaged that the fuel could be ˜75% hydrogen, ˜25% nitrogen with up to 1,000 parts per million of ammonia. The hydrogen may be supplied by an ammonia cracker system, as mentioned above, or it may be supplied by a steam methane reformer, which can utilise methane or biomethane. The hydrogen may also be supplied by an electrolyser. Hydrogen produced using an ammonia cracker system might have a composition of ˜75% hydrogen, ˜25% nitrogen and 0 to ˜1,000 parts per million of residual ammonia.

According to a fifth aspect of the present invention there is provided a power supply system for charging or powering an electrical device, comprising an electrolyte supply system according to the second aspect of the present invention, and a power supply control system electrically connectable to a fuel cell stack to which the electrolyte supply system is fluidly connected, and having a connector mechanism, operable to electrically connect the power supply control system to an electrical device.

In some example arrangements, the power supply system of the fifth aspect of the present invention may comprise an ammonia cracker system, for processing ammonia to produce hydrogen gas, and a fuel conveyor channel connecting the ammonia cracker system to the fuel cell stack, operable to convey the hydrogen gas from the ammonia cracker system to the fuel cell stack.

According to a sixth aspect of the present invention there is provided an electric vehicle charging station comprising a power supply system according to the fourth and fifth aspects of the present invention. In use, an electric vehicle can draw up next to the electric vehicle charging station and an electrical connection can be made between the electric vehicle and the electric vehicle charging station in order to transfer electrical energy to the electric vehicle, for example to charge the batteries on the electric vehicle.

The present invention will be described here with reference to the following figures:

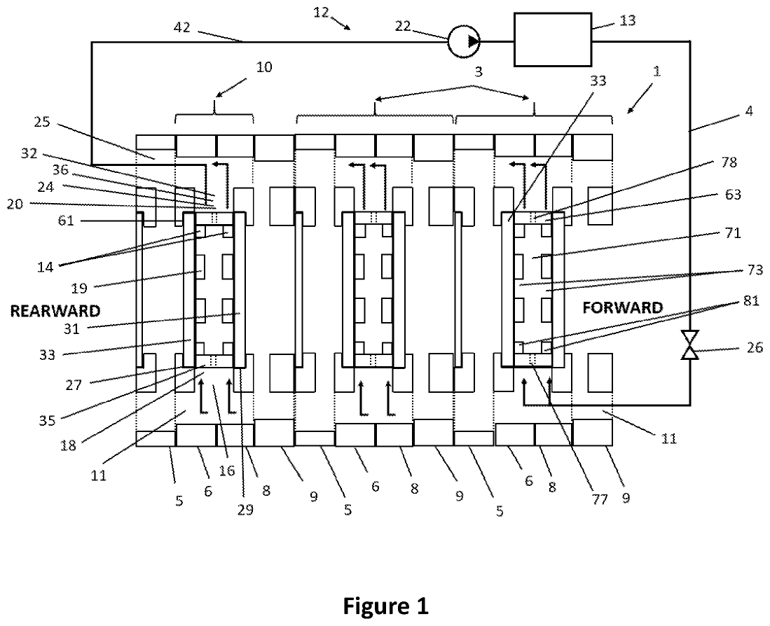

FIG. 1 is a schematic illustration of a cross-section of three electrochemical cells of a fuel cell stack showing the electrolyte flow through each of the electrochemical cells when viewed from one side of the fuel cell stack;

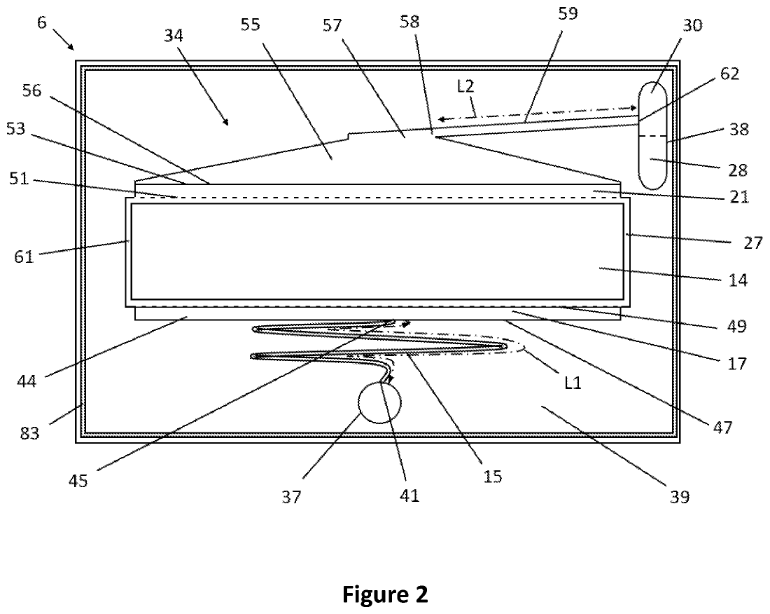

FIG. 2 is a schematic illustration of a cross-section of a rearward electrolyte flow plate;

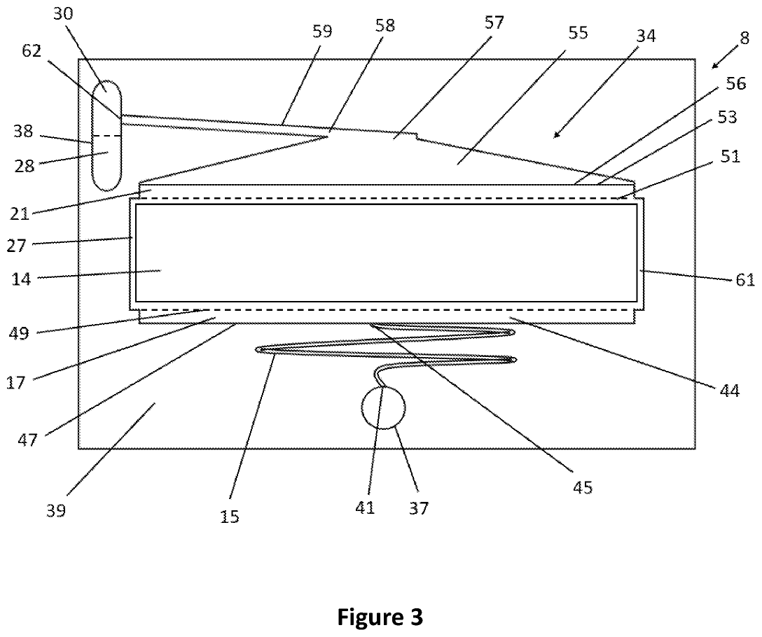

FIG. 3 is a schematic illustration of a cross-section of a forward electrolyte flow plate;

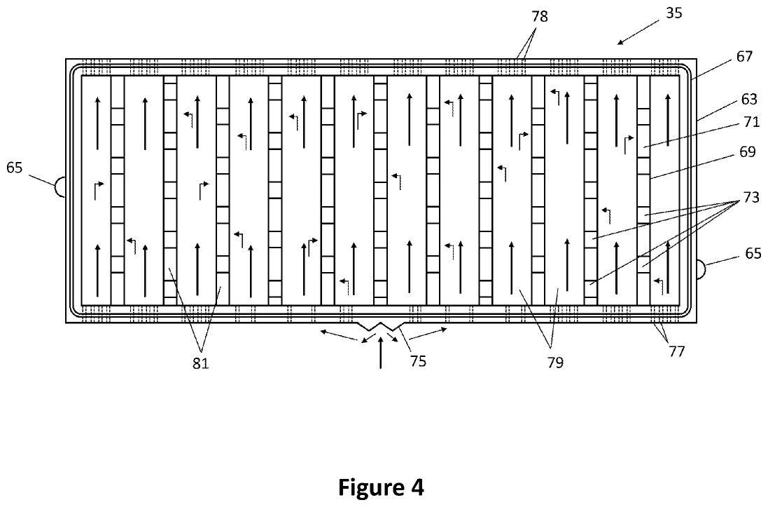

FIG. 4 is a schematic illustration of the forward facing surface of an electrode support;

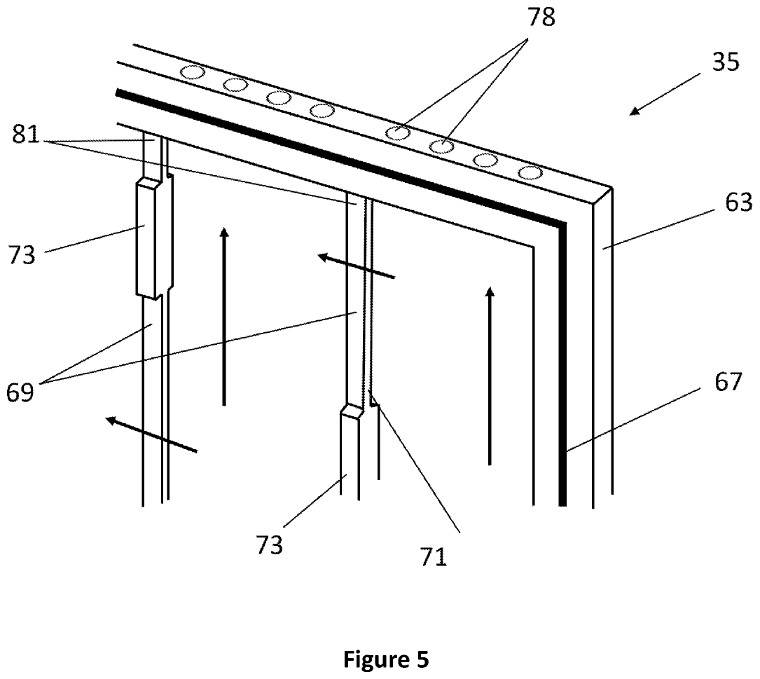

FIG. 5 is a schematic illustration of a perspective view of a corner of the electrode support;

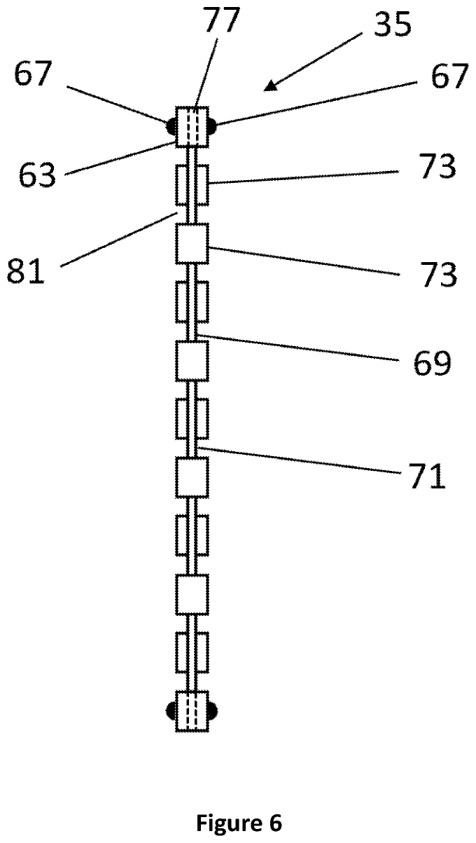

FIG. 6 is a schematic illustration of a cross-section of the electrode support;

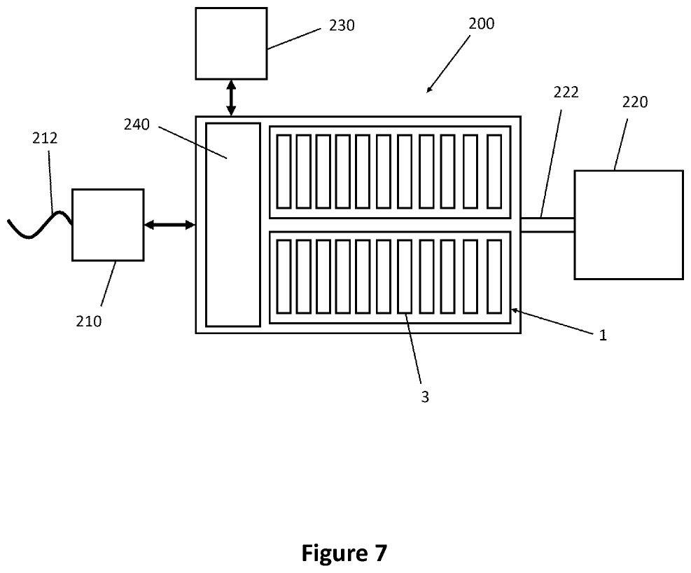

FIG. 7 is a block diagram of an example power supply system for charging an electric vehicle; and

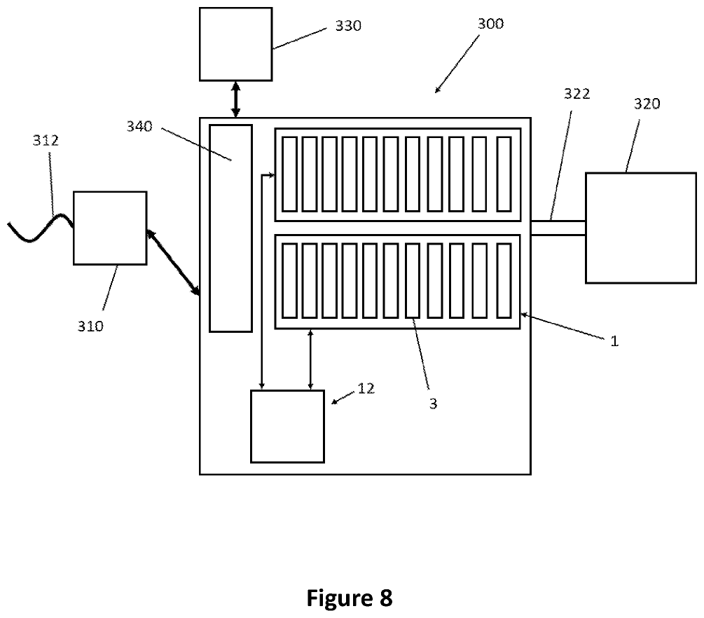

FIG. 8 is a block diagram of a further example power supply system for charging an electric vehicle with an electrolyte supply system.

An arrangement of electrochemical cells 3 in a fuel cell stack 1 according to the present invention is shown in FIG. 1. The figure shows only three electrochemical cells 3 of a fuel cell stack 1. In practice, a fuel cell stack 1 would comprise many more, perhaps one hundred electrochemical cells 3. The electrochemical cells 3 are shown in cross-section and the inflows to and outflows from the electrochemical cells 3 are shown. The figure is schematic and the arrangement of those inflows and outflows has been chosen for the ease of showing all of them in a single cross-section. The illustrated arrangement is not necessarily representative of the relative positioning of the inflows and outflows that would occur in a real fuel cell stack 1.

Each electrochemical cell 3 is made up of an arrangement of an air flow plate 5, a rearward electrolyte flow plate 6, a forward electrolyte flow plate 8 and a fuel flow plate 9. The plates 5,6,8,9 are generally flat, thin, rectangular plates made of a polymer material that have a forward face and a rearward face and four edge faces. The plates 5,6,8,9 have a complementary external profile so that they can be fitted together to form an electrochemical cell 3. The forward and rearward faces are each provided with various features, such as apertures and recesses, as will be described in detail below. The plates 5,6,8,9 are different to each other and are orientated in the arrangement so that the air flow plate 5 abuts the rearward electrolyte flow plate 6 which in turn abuts a forward electrolyte flow plate 8, which in turn abuts a fuel flow plate 9. To construct the fuel cell stack 1 the electrochemical cells 3 are arranged so that the fuel flow plate 9 of one electrochemical cell 3 abuts the air flow plate 5 of an adjoining electrochemical cell 3.

The rearward and forward electrolyte plates 6,8 each have an inward facing side and an outward facing side. The inward facing sides are abutted with each other, when the rearward and forward electrolyte plates 6,8 are assembled into an electrochemical cell 3, and form an electrolyte chamber assembly 10 which has tubes and channels through which electrolyte can flow, as will be described in detail below. The electrolyte chamber assembly 10 is supplied with electrolyte on a recirculating basis as part of an electrolyte supply system 12, as shown schematically in FIG. 1.

An electrolyte chamber 19 is formed within each electrochemical cell 3 by an electrolyte chamber aperture 14 in the rearward electrolyte flow plate 6 and an electrolyte chamber aperture 14 in the forward electrolyte flow plate 8. The electrolyte chamber 19 is bounded on its forward face by a forward gas diffusion electrode 31, on its rearward face by a rearward gas diffusion electrode 33, on its top face by an electrolyte outflow plenum 20 and on its bottom face by an electrolyte inflow plenum 18. The two side faces of the electrolyte chamber 19 are bounded by the body of the rearward and forward electrolyte flow plates 6,8. The electrolyte chamber 19 is located generally in the central third of the height of the electrochemical cell 3, i.e. midway between the top and the bottom of the electrochemical cell 3, with the electrolyte inflow and outflow plenums 18, 20 being located in the bottom and top thirds respectively of the electrochemical cell 3.

The electrolyte inflow plenum 18 is connected to a source of electrolyte via a common electrolyte supply conduit 11. The source of electrolyte is an electrolyte holding tank 13 which is elevated relative to the electrochemical cells 3, so that the electrolyte is fed from the electrolyte holding tank 13 into the electrochemical cells 3 under the force of gravity. The electrolyte outflow plenum 20 is connected to a common electrolyte exhaust conduit 25. An electrolyte pump 22 located in an electrolyte return line 42 pumps the electrolyte from the fuel cell stack 1 back to the electrolyte holding tank 13. An electrolyte inflow valve 26 is located in an electrolyte supply line 4, so that it can be used to control the rate at which electrolyte flows through the common electrolyte supply conduit 11, through the electrolyte inflow plenum 18, through the electrolyte chamber 19, through the electrolyte outflow plenum 20 and through the common electrolyte exhaust conduit 25.

In an alternative embodiment, the electrolyte inflow plenum 18 is connected to a source of electrolyte that is maintained at a pressure level equivalent to the liquid head pressure brought about due to the elevation of holding tank 13. The pressure level can be maintained with a pump.

An electrolyte inflow pipe 16 is provided between the common electrolyte supply conduit 11 and the electrolyte inflow plenum 18. The electrolyte inflow pipe 16 is formed in a forward half and a rearward half, with the forward half provided by an electrolyte inflow channel 15 in the forward electrolyte flow plate 8 and the rearward half provided by an electrolyte inflow channel 15 in the rearward electrolyte flow plate 6.

An inlet end 41 of the electrolyte inflow pipe 16 is fluidly connected to the common electrolyte supply conduit 11 and an outlet end 45 of the electrolyte inflow pipe 16 is fluidly connected to the bottom face of the electrolyte inflow plenum 18, as shown in FIG. 2. The electrolyte inflow plenum 18 is a rectangular cuboid that runs from one side of the electrolyte aperture 19 to the other, across most of the width of the electrochemical cell 3. The height and depth of the electrolyte inflow plenum 18 are small in relation to its width. The top face of the electrolyte inflow plenum 18 is parallel to the top edge of the electrochemical cell 3 (so that, in use, the top face is located horizontally) and is open to the bottom face of the electrolyte chamber 19. The electrolyte chamber 19 is also in the form of a rectangular cuboid, as is the electrolyte outflow plenum 20, and they also both run from one side of the electrochemical cell 3 to the other, across most of the width of the electrochemical cell 3. The electrolyte outflow plenum 20 has a small height and depth relative to its width and thus is similarly shaped and dimensioned to the electrolyte inflow plenum 18. The electrolyte chamber 19 has a much greater height than the height of the electrolyte inflow and outflow plenums 18,20, but its width is still much greater than its height.

The electrolyte inflow plenum 18 is formed in a forward half and a rearward half, with the forward half provided by an electrolyte inflow distribution recess 17 in the forward electrolyte flow plate 8 and the rearward half provided by an electrolyte inflow distribution recess 17 in the rearward electrolyte flow plate 6. The top face of the electrolyte inflow plenum 18 is open to and fluidly connected with the bottom face of the electrolyte chamber 19.

The electrolyte chamber 19 is formed by the electrolyte chamber apertures 14 in the rearward and forward electrolyte plates 6,8. The top face of the electrolyte chamber 19 is open to and fluidly connected with the bottom face of the electrolyte outflow plenum 20. The electrolyte outflow plenum 20 is also formed in two halves, with the forward half provided by an electrolyte outflow collection recess 21 in the forward electrolyte flow plate 8 and the rearward half provided by an electrolyte outflow collection recess 21 in the rearward electrolyte flow plate 6. The top face of the electrolyte outflow plenum 20 is connected to an electrolyte outflow pipe 24, in the form of a funnel, which is connected between the outflow plenum 20 and the common electrolyte exhaust conduit 25.

The electrolyte inflow pipe 16 is elongate, narrow, long, tortuous and of constant rectangular cross-section. It has a length L1, as shown in FIG. 2. The electrolyte inflow channels 15, from which the electrolyte inflow pipe 16 is formed, are square sided recesses that are provided in the surface 39 of the inward face of each of the rearward and forward electrolyte flow plates 6,8. The electrolyte inflow channels 15 extend part way through the depth of the rearward and forward electrolyte flow plates 6,8. The electrolyte inflow tube 16 is fluidly connected to and extends upwards from a circular electrolyte supply aperture 37 that is provided through each of the rearward and forward electrolyte flow plates 6,8. The electrolyte supply aperture 37 is coincident with and forms part of the common electrolyte supply conduit 11 and is located towards the bottom edge of each of the rearward and forward electrolyte flow plates 6,8 and midway between their sides. The path of the electrolyte inflow pipe 16 between the electrolyte supply aperture 37 and the inflow plenum 18 is either horizontal or upwardly slanting.

The electrolyte outflow pipe 24 is formed in a forward half and a rearward half, with the forward half provided by an electrolyte outflow collector 34 in the forward electrolyte flow plate 8 and the rearward half provided by an electrolyte outflow collector 34 in the rearward electrolyte flow plate 6. Each electrolyte outflow collector 34 comprises a tapering recess 55 and an electrolyte outflow channel 59. A mouth 56 is provided at the bottom face of the tapering recess 55 and the mouth 56 is open to and fluidly connected with the top face of the electrolyte outflow plenum 20. The tapering recess 55 tapers inwardly from a relatively wide mouth 56 to a relatively narrow throat 57. The throat 57 is connected to the electrolyte outflow channel 59. The electrolyte outflow collectors 34 combine to form an electrolyte outflow funnel 36. The electrolyte outflow channels 59 combine to form an electrolyte outflow duct 32.

The electrolyte outflow duct 32 extends between the throat 57 and the electrolyte exhaust aperture 38 that is provided through each of the rearward and forward electrolyte flow plates 6,8. The electrolyte exhaust aperture 38 is coincident with and forms part of the common electrolyte exhaust conduit 25 and is located towards the top edge of each of the rearward and forward electrolyte flow plates (8,6) and towards one or other top corner (dependent upon the direction in which it is viewed).

The electrolyte chamber 19 is bounded at its forward face by the forward gas diffusion electrode 31 and at its rearward face by the rearward gas diffusion electrode 33. The inward facing side of the rearward and forward electrolyte flow plates 8,6 are each provided with a recess that forms a forward inward facing shelf 27, as shown in FIGS. 2 and 3. The inward facing shelves 27 extend sideways from the electrolyte chamber apertures 14, in the plane of the rearward and forward electrolyte plates 6,8, to each form a constant width shelf that frames the electrolyte chamber aperture 14. In an electrochemical cell 3, the forward and rearward gas diffusion electrodes 31,33 are located within the recesses around which the shelves 27 extend. The thickness of the forward and rearward gas diffusion electrodes 31,33 is no greater than the depth of the recesses that form the inward facing shelves 27, and when located within the recesses the gas diffusion electrodes 31, 33 do not protrude above the inward facing surfaces of the rearward and forward electrolyte flow plates 6,8. Within the electrochemical cell 3, the region within the electrolyte chamber apertures 14 and between the forward and rearward gas diffusion electrodes 31, 33 forms the electrolyte chamber 19.

A sealing strip 83 is provided on the surface 39 of the inward facing side of the rearward electrolyte flow plate 6, as shown in FIG. 2. The sealing strip 83 forms a seal between the rearward and forward electrolyte flow plates 6,8 around the electrolyte carrying components, thus preventing electrolyte from leaking out of the electrochemical cell 3.

An electrode support 35 is located within the electrolyte chamber 19, between the forward and rearward gas diffusion electrodes 31,33. When the plates 5,6,8,9 are assembled into an electrochemical cell 3, the forward and rearward gas diffusion electrodes 31, 33 abut the electrode support 35. The electrode support 35 is shown in FIG. 4. The width and height of the electrode support 35 is the same as the width and height of the forward and rearward gas diffusion electrodes 31, 33 and therefore the electrode support 35 is also located within the recesses associated with the inward facing shelves 27.

Additional detail about the construction of the rearward electrolyte flow plate 6 and the forward electrolyte flow plate 8 will now be provided with reference to FIGS. 2 and 3. The rearward and forward electrolyte flow plates 6,8 are each made from a rectangular sheet of a polymer material that is thin relative to its height and width and the width of the electrolyte flow plates 6,8 is greater than their height. The rearward and forward electrolyte flow plates 6,8 each have three regions where the material of the sheet is removed entirely, so that there are three openings through the entire thickness of the electrolyte flow plates 6,8. The first opening is the circular electrolyte supply aperture 37, that forms part of the common electrolyte supply conduit 11 when the fuel cell stack 1 has been assembled. The second opening is the electrolyte chamber aperture 14, which helps to form the electrolyte chamber 19. The third is the electrolyte exhaust aperture 38, that forms part of the common electrolyte exhaust conduit 25 when the fuel cell stack 1 has been assembled.

The electrolyte chamber 19 is rectangular in cross-section, in the plane of the rearward and forward electrolyte flow plates 6,8, its long sides are parallel to the long sides of the rearward and forward electrolyte flow plates 6,8 and its short sides are parallel to their short sides.

The common electrolyte exhaust conduit 25 runs through the length of the fuel cell stack 1, through the plates 5,6,8,9 of each of the electrochemical cells 3 within the fuel cell stack, and is made up by apertures provided in each of those plates 5,6,8,9. The electrolyte exhaust aperture 38 of the rearward and forward electrolyte flow plates 6,8 is one of those apertures. The common electrolyte exhaust conduit 25, and therefore the electrolyte exhaust aperture 38, have a cross-sectional profile that is in the shape of an elongate rectangle with curved ends. It is oriented so that the long edges of the rectangle are parallel with the sides (i.e. the short edges) of the fuel cell stack 1. The common electrolyte exhaust conduit 25 passes through all of the plates 5,6,8,9 but it receives electrolyte only from the electrolyte chamber assembly 10 of each electrochemical cell 3. The common electrolyte exhaust conduit 25 can be considered as having a top part that provides a gas flow region 30 and a bottom part that provides an electrolyte flow region 28, as indicated by the dotted line in FIG. 2. The electrolyte outflow pipe 24 is fluidly connected with the gas flow region 30. The common electrolyte exhaust conduit 25 is part of the electrolyte supply system 12.

The inlet end 41 of the electrolyte inflow channel 15 is fluidly connected to the electrolyte supply aperture 37 and the outlet end 45 of the electrolyte inflow channel 15 opens into the electrolyte inflow distribution recess 17 in the middle of its width.

The electrolyte inflow distribution recess 17 and the electrolyte outflow collection recess 21 are both elongate, having a width much greater than their height, and they both extend across most of the width of the rearward and forward electrolyte flow plates 6,8 and across all of the width of the electrolyte chamber 19. The recesses 17,21 are formed in the surface 39 of the inward facing side of each of the rearward and forward electrolyte flow plates 6,8 and extend part way through the depth of the sheet from which the rearward and forward electrolyte flow plates 6,8 are formed. The lower face 47 of the electrolyte inflow distribution recess 17 has only one opening, the outlet end 45 of the electrolyte inflow channel 15. The upper face 49 of the electrolyte inflow distribution recess 17 is open to and fluidly connected with the bottom edge of the electrolyte chamber 19. The upper face 49 has no obstructions, channels or the like and is thus completely open to the electrolyte chamber 19.

The lower face 51 of the electrolyte outflow collection recess 21 is also completely open to and fluidly connected with the top face of the electrolyte chamber 19. The upper face 53 of the electrolyte outflow collection recess 21 is completely open to and fluidly connected with the tapering recess 55. The recess that forms the tapering recess 55 is shallower than the recess that forms the electrolyte outflow collection recess 21. There is therefore a step formed between the upper face 53 of the electrolyte outflow collection recess 21 and the lower face of the tapering recess 55.

The tapering recess 55 of the electrolyte outflow channel 34 tapers from a maximum width at its bottom edge to a minimum width at its top edge. The throat 57 is located at the top edge of the tapering recess 55 and fluidly connects the tapering recess 55 to an inlet 58 of an electrolyte outflow channel 59. The electrolyte outflow channel 59 is elongate, narrow, long, straight-sided and of constant cross-section and is attached at its downstream end to the electrolyte exhaust aperture 38 at an outlet. The electrolyte outflow channel 59 has a length L2, as shown in FIG. 2. The electrolyte outflow channel 59 is shorter than the electrolyte inflow channel 15 (length L1 is greater than length L2).

The electrolyte outflow channel 34 is created by forming a square sided recess in the surface 39 of the inward facing side of the rearward and forward electrolyte flow plates 6,8. The recess extends part way through the depth of the sheet from which the rearward and forward electrolyte flow plates 6,8 are formed. When the electrochemical cell 3 is assembled and the rearward and forward electrolyte flow plates 6,8 are abutted, the tapering recess 55 and the electrolyte outflow channel 55 on each of the rearward and forward electrolyte flow plates 6,8 are aligned which each other to create an electrolyte outflow pipe 24 that fluidly connects the electrolyte outflow plenum 20 to the common electrolyte exhaust conduit 25.

In relation to the structure of the electrolyte chamber 19, the forward and rearward gas diffusion electrodes 31, 33 are thin flexible sheets which are supported by the electrode support 35. The forward and rearward gas diffusion electrodes 31,33 and the electrode support 35 are rectangular and are slightly smaller in width and in height than an electrode recess 61 that is created by the inward facing shelves 27. This enables the forward and rearward gas diffusion electrodes 31,33 to fit within the electrode recess 61.

The electrode support 35, as illustrated in FIG. 4, comprises a rectangular external frame 63 and the frame 63 has a rectangular cross-sectional profile. The frame 63 has two short sides, left and right, and two long sides, top and bottom. The frame 63 has a forward face and a rearward face and an internal side surface and an external side surface around its interior and exterior perimeters. A locator lug 65 is provided on the external side surface of each of the left and right hand short sides. The locator lug 65 on the left hand side is nearer to the top side than the locator lug 65 on the right hand side. The locator lugs 65 prevent the electrode support 35 from being assembled in an incorrect orientation and they hold the electrode support 35 within the electrode recess 61 so that an electrolyte distribution cavity 44 is created between the bottom wall of the electrode recess 61 and the external perimeter of the frame 63 of the electrode support 35. A frame seal 67 is located around the entire frame 63 on each of the forward and rearward faces. A plurality of spaced apart vertical bars 69 are located within the frame 63 and are attached to the internal side surface of the frame 63 and both of their ends. The vertical bars 69 have a spine 71 with support bosses 73 located on either side. A deflector 75 is provided midway along the bottom side of the frame 63. Bottom flow apertures 77 pass through the bottom side of the frame 63 and top flow apertures 78 pass through the top side of the frame 63.

The vertical bars 69 are parallel to the sides of the frame 63 and are evenly spaced within the frame so that vertical flow paths 79 are created. The spine 71 of each the vertical bars 69 has a depth, i.e. a dimension in the forward/rearward direction, that is lower than the depth of the frame 63. The support bosses 73 have a depth that is equal to the depth of the frame 63. A crossflow channel 81 is created between adjacent vertical flow paths 79 at each section of the spine 71 where no support boss 73 is present. The support bosses 73 on one vertical bar 69 are offset in a vertical direction from the support bosses 73 on an immediately adjacent vertical bar 69. The bottom and top flow apertures 77,78 are located in groups, with each group in a section of the frame 63 that is adjacent to a vertical flow path 79. The top flow apertures 78 that pass through the top side of the frame 63 are provided in groups of four top flow apertures 78 and those four top flow apertures 78 are evenly spaced from each other within their group. The bottom flow apertures 77 that pass through the bottom side of the frame 63 are provided in groups with differing numbers of bottom flow apertures 77. The groups to the left hand side and right hand side of the bottom side of the frame 63 are each provided with four bottom flow apertures 77 and these four bottom flow apertures are evenly spaced from each other. The groups in the middle of the bottom side of the frame 63 are provided with two bottom flow apertures 77 and the two bottom flow apertures within these groups may be spaced at different distances from each other. The diameter of all of the bottom and top flow apertures 77,78 is the same and is less than the depth of the frame 63. The bottom and top flow apertures 77,78 are straight-sided.

In the use of a fuel cell stack 1, electrolyte, for example potassium hydroxide (KOH), is supplied to the electrochemical cells 3, in order that the fuel cell stack 1 can provide electrical power to an external appliance. The electrolyte is located in the electrolyte holding tank 13 and is supplied to the electrochemical cells 3 of the fuel cell stack 1 via the electrolyte supply line 4 and the common electrolyte supply conduit 11. The rate of flow of the electrolyte through the common electrolyte supply conduit 11 is controlled, at least in part, by the electrolyte inflow valve 26. The following description will describe the flow of electrolyte through one electrochemical cell 3. The flow of electrolyte through the other electrochemical cells 3 in the fuel cell stack 1 will be the same.

The electrolyte passes from the common electrolyte supply conduit 11 into the electrolyte supply apertures 37 of the rearward and forward electrolyte flow plates 6,8 and then onwards through the electrolyte inflow pipe 16 to the electrolyte inflow plenum 18. The inflow pipe 16 act as an ionic resistor.

The electrolyte passes out of the inflow pipe 16 into the electrolyte inflow plenum 18 where it contacts the deflector 75 of the electrode support 35 and is deflected to both sides of the electrolyte inflow plenum 18. The deflected electrolyte flows outwardly through the electrolyte inflow plenum 18 to fill all of the electrolyte distribution cavity 44. The pressure of the electrolyte will reduce as the distance away from the deflector 75 increases and it is for this reason that the groups of bottom flow apertures 77 furthest from the deflector 75 have a greater number of bottom flow apertures 77, that provide a greater open flow area, than the numbers of bottom flow apertures 77 in the groups nearer to the deflector 75 (alternatively, each group of bottom flow apertures 77 can be replaced with just one single aperture, wherein the size of the open flow area of each such single aperture can be varied according to its distance from the deflector 75, with the open flow area of the aperture furthest from the deflector 75 being greater than the open flow area of the aperture nearest to the deflector 75). This facilitates an even distribution of electrolyte across the width of the electrolyte chamber 19. The electrolyte then flows up through the bottom flow apertures 77 into the vertical flow paths 79 within the electrolyte chamber 19. A proportion of the electrolyte will flow directly upwards through the flow paths 79 and a proportion of the electrolyte will pass across the vertical bars 69 into an adjacent flow path 79. The electrolyte then passes out of the electrolyte chamber 19 through the top flow apertures 78, into the electrolyte outflow plenum 20 and then out of the electrolyte outflow plenum 20 into the electrolyte outflow funnel 24. The area of the outflow face of the electrolyte outflow plenum 20 is greater than the area of the inflow face to the electrolyte outflow funnel 24 and this difference in area provides a further means for balancing the flow of electrolyte through the electrochemical cell 3. The adjoining tapering recesses 55 of the rearward and forward electrolyte flow plates 6,8 cause the electrolyte to be funneled towards the throats 57 and then onwards into the electrolyte outflow duct 32. The electrolyte outflow duct 32 acts as an ionic resistor for the flow of electrolyte into the electrolyte exhaust aperture 38 and then into the common electrolyte exhaust conduit 25. The electrolyte leaves the electrolyte outflow duct 32 and drops to the bottom of the electrolyte exhaust aperture 38, from where it passes into the common electrolyte exhaust conduit 25, flows into the electrolyte return line 42 and is pumped back to the electrolyte holding tank 13 by the electrolyte pump 22. An amount of electrolyte remains in the electrolyte exhaust conduit 25 and the upper surface of the electrolyte in the electrolyte exhaust conduit 25 is maintained at a level that is lower than the outlet from the electrolyte outflow duct 32. The gas flow region 30 of the common electrolyte exhaust conduit 25 allows gas, for example gas present at start-up during initial fill of electrolyte, to leave the electrolyte before the electrolyte is recirculated through the fuel cell stack 1.

The flow of electrolyte into the electrolyte chamber 19 is determined by the geometry of the electrolyte inflow pipe 16, the flow setting of the electrolyte inflow valve 26 and the head of the electrolyte holding tank 13. The electrolyte inflow pipe can be made to be long with a small cross-sectional area so that it provides a high ionic resistance and thus reduces the ionic leakage current associated with the inflow side of the electrochemical cell 3. The geometry of the electrolyte inflow valve will restrict the flow of electrolyte into the electrochemical cell 3, but this can be compensated for by increasing the pressure at which the electrolyte is supplied to the common electrolyte supply conduit 11.

The flow of electrolyte from and the pressure within the electrolyte chamber 19 is determined by the geometry of the electrolyte outflow pipe 24, in particular by the geometry of the electrolyte outflow duct 32. In this embodiment of the present invention, the ionic resistance of the electrolyte outflow duct 32 is designed to achieve as high an ionic resistance as possible whilst still balancing the pressure profile needed to achieve the required electrolyte flow through the chamber.

FIG. 7 illustrates an example electric vehicle (EV) charging system 200 comprising a charging terminal 210, to which an electric vehicle (not shown) can be electrically connected by a cable 212, a fuel cell stack 1 of electrochemical fuel cells 3 is connected to a balance of plant and power electronics 240 as disclosed herein, a battery storage system 230 may or may not be connected, either an ammonia cracking system, a hydrogen gas storage system or a direct hydrogen feed from another source 220 is connected via a tube 222 for conveying a hydrogen gas blend, e.g. a blend of hydrogen and nitrogen from the ammonia cracking or hydrogen system 220 to the fuel cell stack 1. Some example EV charging systems 200 may have the aspect of allowing EVs to be charged in remote locations, in which there is little or no access to an electricity grid.

FIG. 8 illustrates an example electric vehicle (EV) charging system 300 comprising a charging terminal 310, to which an electric vehicle (not shown) can be electrically connected by a cable 312, a fuel cell stack 1 of electrochemical fuel cells 3 is connected to a balance of plant and power electronics 340 as disclosed herein, a battery storage system 330 may or may not be connected. An electrolyte supply system 12 provides electrolyte to the fuel cell stack 1. Either an ammonia cracking system, a hydrogen gas storage system or a direct hydrogen feed from another source 320 is connected via a tube 322 for conveying a hydrogen gas blend, e.g. a blend of hydrogen and nitrogen from the ammonia cracking or hydrogen system 320 to the fuel cell stack 1. Some example EV charging systems 300 may have the aspect of allowing EVs to be charged in remote locations, in which there is little or no access to an electricity grid.

GB1375437 and WO2007102028 relate to known fuel cells in the art, including known liquid electrolyte flow plates. Neither document discloses an electrolyte chamber assembly having the advantageous features of the present invention.

1. An electrolyte chamber assembly (10) for an electrochemical cell (3), the assembly comprising a forward electrolyte flow plate (8) and a rearward electrolyte flow plate (6), each having an inward facing side and an outward facing side, wherein each inward facing side is provided on its surface with an electrolyte inflow channel (15) and an electrolyte outflow collector (34) and an electrolyte chamber aperture (14) that passes between the surface of the inward facing side and the surface of the outward facing side of each of the forward electrolyte flow plate (8) and the rearward electrolyte flow plate (6), wherein the electrolyte inflow channel (15), the electrolyte outflow collector (34) and the electrolyte chamber aperture (14) on the inward facing side of one of the electrolyte flow plates (6,8) are mirror images of the electrolyte inflow channel (15), the electrolyte outflow collector (34) and the electrolyte chamber aperture (14) on the inward facing side of the other of the forward and rearward electrolyte flow plates (8,6), wherein the forward and rearward electrolyte flow plates (8,6) are held against each other in the electrolyte chamber assembly (10) and the inward facing side of the forward electrolyte flow plate (8) and the inward facing side of the rearward electrolyte flow plate (6) are held in abutment with each other, whereby the two electrolyte inflow channels (15) create together an electrolyte inflow pipe (16), the two electrolyte outflow collectors (34) create together an electrolyte outflow pipe (24) and the two electrolyte chamber apertures (14) create together an electrolyte chamber (19), and wherein the electrolyte inflow pipe (16) has an inlet end (41) for receiving electrolyte into the electrolyte chamber assembly (10) and an outlet end (45) fluidly connected to the electrolyte chamber (19) and the electrolyte outflow pipe (24) has an inlet end (56) connected to the electrolyte chamber (19) and an outlet end (62) for exhausting electrolyte from the electrolyte chamber assembly (19).

2. An electrolyte chamber assembly (10) as claimed in claim 1, wherein the electrolyte outflow collectors (34) each comprise a tapering recess (55) and an electrolyte outflow channel (59), the tapering recess (55) tapers from a mouth (56) to a throat (57), the mouth (56) is fluidly connected to the electrolyte chamber aperture (14) and the throat (57) is fluidly connected to the electrolyte outflow channel (59), wherein, when the forward and rearward electrolyte flow plates (8,6) are abutted with each other, the tapering recesses (55) create together an electrolyte outflow funnel (36) and the electrolyte outflow channels (59) of the forward and rearward electrolyte flow plates (8,6) create together an electrolyte outflow duct (32), which are each part of the electrolyte outflow pipe (24).

3. An electrolyte chamber assembly (10) as claimed in claim 2, wherein each electrolyte outflow channel (59) is straight-sided and the electrolyte outflow duct (32 is a straight-sided duct.

4. An electrolyte chamber assembly (10) as claimed in any one of claim 1, 2 or 3, wherein each forward and rearward electrolyte flow plate (8,6) is provided on the surface (39) of its inward facing side with an electrolyte inflow distribution recess (17) which together create an electrolyte inflow plenum (18) and the downstream end of the electrolyte inflow pipe (16) is connected to the electrolyte inflow plenum (18) substantially at the centre point of the transverse width of the electrolyte inflow plenum (18).

5. An electrolyte chamber assembly (10) as claimed in any one of the preceding claims, wherein each of the forward and rearward electrolyte flow plates (8,6) is provided on the surface (39) of its inward facing side with an electrolyte outflow collection recess (21) and the electrolyte outflow collection recesses (21) together create an electrolyte outflow plenum (20), wherein the inlet end (58) of the electrolyte outflow pipe (24) is fluidly connected to the electrolyte outflow plenum (20).

6. An electrolyte chamber assembly (10) as claimed in claim 5, wherein the depth of the electrolyte outflow plenum (20) is greater than the depth of the electrolyte outflow funnel (36), when the depths are measured in a direction perpendicular to the surfaces of the forward and rearward electrolyte flow plates (8,6).

7. An electrolyte chamber assembly (10) as claimed in any preceding claim, wherein the electrolyte inflow pipe (16) is elongate and is tortuous.

8. An electrolyte chamber assembly (10) as claimed in claim 3, wherein the length of the electrolyte outflow duct (32) is less than the length of the electrolyte inflow pipe (16).

9. An electrolyte chamber assembly (10) as claimed in any preceding claim, wherein each or the forward and rearward electrolyte flow plates (8,6) further comprises an electrolyte supply aperture (37) and an electrolyte exhaust aperture (38) which each pass through the forward and rearward electrolyte flow plates (8,6) between the surface of their inward facing sides and the surface of their outward facing sides and wherein the electrolyte inflow channel (15) is connected at its inlet end (41) to the electrolyte supply aperture (37) and the electrolyte outflow channel (59) is connected at its outlet end (62) to the electrolyte exhaust aperture (38).

10. An electrolyte chamber assembly (10) as claimed in claim 9 wherein the electrolyte exhaust aperture (38) has an electrolyte flow region (28) and a gas flow region (30) and wherein the interface between the electrolyte outflow pipe (24) and the electrolyte exhaust aperture (38) is located within the gas flow region (30).

11. An electrolyte chamber assembly (10) as claimed in any preceding claim, wherein each electrolyte chamber aperture (14) is provided with an electrode shelf recess (61) that is located around the perimeter of the electrolyte chamber aperture (14) and that is formed by an inward facing shelf (27) that extends into the surface (39) of the inward facing side of each of the forward and rearward electrolyte flow plates (8,6).

12. An electrolyte chamber assembly (10) as claimed in any preceding claim, further comprising an electrode support (35) located within the electrolyte chamber (19), wherein the electrode support (35) is provided with a plurality of support bosses (73) spaced apart by flow paths (79) and an inflow side and an outflow side, wherein each of the inflow side and the outflow side are provided with a plurality of flow apertures (77,78) that are fluidly connected to the flow paths (79).

13. An electrolyte chamber assembly (10) as claimed in claim 12, wherein the flow apertures (77,78) are arranged into groups that are aligned with the flow paths (79) and the flow apertures (77) on the inflow side are not evenly spaced within their groups and the flow apertures (78) on the outflow side are evenly spaced within their groups.

14. An electrolyte chamber assembly (10) as claimed in claim 12 or claim 13, wherein the electrode support (35) has an external frame (63), a plurality of internal bars (69) located inside the frame (63), attached to the frame (63) and spaced apart from each other to create the flow paths (79), the internal bars (69) each comprising a spine (71), on the forward and rearward sides of which spine (71) are provided a plurality of the support bosses (73), the spaces between the support bosses (73) creating cross-flow channels (81) between adjacent flow paths (79).

15. An electrolyte chamber assembly (10) as claimed in any one of claim 12, 13 or 14, wherein the inflow side of the electrode support (35) is provided with a deflector (75) at its centre point and the electrode support (35) is located within the electrolyte chamber (19) so that the deflector (75) is positioned adjacent to the outlet end (45) of the electrolyte inflow pipe (16), the deflector (75) having deflection surfaces which, in use, deflect electrolyte leaving the electrolyte inflow pipe (16) to either side of the centre point on the electrode support (35).

16. An electrolyte chamber assembly (10) as claimed in any preceding claim wherein the electrolyte inflow pipe (16) has a higher ionic resistance than the electrolyte outflow pipe (24).

17. An electrolyte supply system (12) for a fuel cell stack (1) with a plurality of electrochemical cells (3), each of the electrochemical cells (3) having an electrolyte chamber (19) connected to an electrolyte inflow pipe (16) and an electrolyte outflow pipe (24), the electrolyte supply system (12) comprising a common electrolyte supply conduit (11), through which, in use, electrolyte is supplied to each of the electrochemical cells (3) via the electrolyte inflow pipe (16), and a common electrolyte exhaust conduit (25), through which, in use, electrolyte leaves each of the electrochemical cells (3) via the electrolyte outflow pipe (24), wherein the common electrolyte exhaust conduit (25) has an electrolyte flow region (28) located beneath a gas flow region (30) and the interface between the electrolyte outflow pipe (24) and the common electrolyte exhaust conduit (25) is located in the gas flow region (30), wherein each of the electrochemical cells (3) comprise an electrolyte chamber assembly (10) according to any one of claims 1 to 16.

18. An electrolyte supply system (12) as claimed in claim 17 further comprising an electrolyte reservoir (13) located at a height greater than the height of the fuel cell stack (1), or an equivalent inlet pressure, an electrolyte supply line (4) located between the reservoir (13) and the common electrolyte supply conduit (11) and an electrolyte return line (42) located between the common electrolyte exhaust conduit (25) and the reservoir (13), so that electrolyte can flow into the electrochemical cells (3) under the force of gravity, an electrolyte pump (22) in the electrolyte return line (42) and an electrolyte inflow control valve (26) in the electrolyte supply line (4).

19. An electrolyte supply system (12) as claimed in claim 17 or claim 18, wherein the ionic resistance of the inflow pipe (16) is greater than the ionic resistance of the outflow pipe (24).

20. A fuel cell stack (1) comprising a plurality of electrochemical cells (3), each electrochemical cell having an electrolyte chamber assembly (10) according to any one of claims 1 to 16.

21. A power supply system (200) for charging or powering an electrical device, comprising a fuel cell stack (1) as claimed in claim 20, and a power supply control system (210) electrically connected to the fuel cell stack (1), and having a connector mechanism (212), operable to electrically connect the power supply control system (210) to an electrical device.

22. A power supply system (200) as claimed in claim 21, comprising an ammonia cracker system (220), for processing ammonia to produce hydrogen gas, and a fuel conveyor channel (222) connecting the ammonia cracker system (220) to the fuel cell stack (1), operable to convey the hydrogen gas from the ammonia cracker system (220) to the fuel cell stack (1).

23. A power supply system (300) for charging or powering an electrical device, comprising an electrolyte supply system (12) as claimed in any one of claims 17 to 19, and a power supply control system (310) electrically connectable to a fuel cell stack to which the electrolyte supply system (12) is fluidly connected, and having a connector mechanism (312), operable to electrically connect the power supply control system (310) to an electrical device.

24. A power supply system (300) as claimed in claim 23, comprising an ammonia cracker system (320), for processing ammonia to produce hydrogen gas, and a fuel conveyor channel (322) connecting the ammonia cracker system (320) to the fuel cell stack (1), operable to convey the hydrogen gas from the ammonia cracker system (320) to the fuel cell stack (1).

25. An electric vehicle charging station comprising a power supply system (200, 300) according to any of claims 21 to 24.
